(19) United States
(12) Patent Application Publication
(10) Pub. No.: US 2020/0001314 A1
(43) Pub. Date: Jan. 2, 2020

(54) SHOWER HEAD BUTTON SWITCHING STRUCTURE

(71) Applicant: Purity (Xiamen) Sanitary Ware Co., Ltd., Xiamen (CN)

(72) Inventors: Xiwen Yang, Xiamen (CN); Jiayuan Huang, Xiamen (CN); Xingchuan Ling, Xiamen (CN); Guozhong Wu, Xiamen (CN); Weisheng Wu, Xiamen (CN); Jinlong Wu, Xiamen (CN)

(21) Appl. No.: 16/022,697

(22) Filed: Jun. 29, 2018

(51) Int. Cl. B05B 12/00; A47K 3/28; B05B 1/16; B05B 1/18; E03C 1/08

(52) U.S. Cl. CPC B05B 12/002; A47K 3/28; E03C 1/08; B05B 1/18; B05B 1/16

(57) ABSTRACT

A shower head button switching structure includes a sealing seat, a fixing seat, a button, a push block, a push lever, a driving disk, a driven disk, a positioning block, and a sealing disk. The outer periphery of the driving disk is formed with a gear portion. The front end of the push lever is formed with a rack. The push lever can be reciprocated back and forth to drive the driving disk to rotate. The driven disk is fitted in the driving disk. The positioning block is obliquely installed in the driving disk. The outer periphery of the driven disk is formed with teeth arranged annularly. This structure achieves a smoother and more stable water flow switching function.

### BACKGROUND OF THE INVENTION

### 1. Field of the Invention

The present invention relates to a bathroom accessory, and more particularly to a shower head button switching structure.

### 2. Description of the Prior Art

A conventional button switching structure in the sanitary ware industry is to push a pull rod connected with a driving disk through a button, so as to drive a driven disk disposed above or below the driving disk, and then to drive a sealing disk to rotate, thereby realizing the switching of spray patterns.

CN201420658855 discloses a button control discharge mechanism, which comprises a linkage mechanism composed of a push block and a pull rod. Through the linkage mechanism, the button drives a driven switch assembly to achieve water flow switching. The specific action is that: the button is pressed to push the push block, the push block pulls the pull rod backward, and the pull rod drives the driving disk to rotate the driven disk. The driving disk and the driven disk are arranged in the form of upper and lower layers. The driving disk is provided with four toothed surfaces to cooperate with the driven disk. The driven disk and the sealing disk are driven by the driving disk to achieve the switching function. During the returning, a tension spring directly pulls the driving disk to be returned. The driving disk may float upward to disengage from the driven disk due to the cooperation of the toothed surfaces.

The disadvantages are as follows: 1. The pull rod needs to be fixedly connected to the driving disk. The pull rod is easily deformed during operation or may be jammed, resulting in an unsmooth switching. 2. The driving disk and the driven disk are arranged in the form of upper and lower layers, which needs a large space in height, therefore, the shower head must be larger in thickness.

U.S. Pat. No. 6,622,945 discloses a shower head structure. The shower head structure is provided with a switching structure. A swing rod is pressed to push a retractable positioning block to drive a gear disk (a driven disk) to rotate, thereby achieving water flow switching. The acting force for the positioning block of the switching structure to drive the driven disk to rotate is not a tangential force of the rotational direction of the driven disk. The positioning block is pushed along a straight line or oblique line to engage with the teeth of the driven disk. The driven disk can only obtain a component force when the swing rod is moved. The positioning block cannot be always in contact with the teeth. As a result, the switching structure needs a large external force for operation. The force is unstable, and the operation is difficult.

CN201621422830 discloses a shower head push rod switching discharge structure, comprising a fixing seat, a pull rod, a push rod, a connecting shaft, a ratchet wheel (driving disk), a ratchet pawl (driven disk), and a rotating disk (sealing cover). The push rod drives the pull rod to move in a horizontal direction. The lateral shift of the pull rod is converted into the axial rotation of the ratchet wheel, and then the ratchet wheel drives the ratchet pawl to rotate so as to drive the connecting shaft and the rotating disk to rotate. The rotating disk is rotated for its water hole to communicate with the water diversion holes (formed on the sealing cover) for switching spray patterns. The structure uses the teeth on the inner ring of the ratchet wheel and the elastic pawl to achieve the synchronous rotation of the ratchet wheel and the ratchet pawl. When the ratchet wheel is rotated and returned, the elastic pawl is deformed to prevent the ratchet pawl from being returned. After the ratchet wheel is returned, the elastic pawl is engaged with the next tooth to achieve a non-return function. The switching discharge structure has the following defects: 1) The movement of the entire product driven by the pull rod is inconvenient for manipulation. 2) The deformation of the elastic pawl may cause the ratchet wheel to be jammed during the retuning to affect the next switching process. 3) The push rod achieves the linkage connection with the ratchet wheel through a groove and a protrusion embedded in the groove. The stability of the connection is not enough.

Accordingly, the inventor of the present invention has devoted himself based on his many years of practical experiences to solve these problems.

### SUMMARY OF THE INVENTION

The primary object of the present invention is to provide a shower head button switching structure to achieve a smoother and more stable water flow switching function.

In order to achieve the aforesaid object, the shower head button switching structure of the present invention comprises a sealing seat, a fixing seat, a button, a push block, a push lever, a driving disk, a driven disk, a positioning block, and a sealing disk. A middle portion of the push block is pivotally connected to the sealing seat. A free end of the button is connected to one end of the push block in such a manner that the push block can be pressed to swing upward. An upper surface of the sealing seat is formed with a limiting guide slot. A front end of the push lever is inserted in the limiting guide slot and movable back and forth. A rear end of the push lever is connected to another end of the push block. When the push block is swung upward, the push lever is driven by the push block to move forward. The front end of the push lever is formed with a rack. An outer periphery of the driving disk is formed with a gear portion to mesh with the rack. When the push lever is reciprocated to move back and forth, the driving disk is driven by the push lever to rotate through the rack to cooperate with the gear portion. A return spring is provided between the push lever and the sealing seat. The return spring is compressed when the push lever is moved forward. When the button is not applied with an external force, the push lever is pushed back by the return spring to drive the push block to swing downward and to return the free end of the button and the driving disk back. The driven disk is disposed in the driving disk. The positioning block is obliquely installed in the driving disk in a retractable manner. An outer periphery of the driven disk is formed with teeth arranged annularly. One end of the positioning block is formed with an oblique end corresponding to the teeth of the driven disk. When the positioning block extends outward, the oblique end of the positioning block is engaged with one of the teeth of the driven disk. Through the oblique end of the positioning block to cooperate with the teeth of the driven disk, the driving disk is able to drive the driven disk to rotate in one direction. When the driving disk is rotated and returned back, the positioning block is retraced by the teeth of the driven disk so that the driven disk is not rotated and returned back, enabling the oblique end of the positioning block to be engaged with the next one of the teeth of the driven disk. The sealing disk is coaxially connected with the driven disk so that when the driving disk drives the driven disk to rotate, the sealing disk can be simultaneously rotated to achieve water flow switching.

Preferably, the driving disk is formed with an oblique groove. The positioning block is inserted in the oblique groove. A compression spring is sleeved on the positioning block. One end of the compression spring elastically abuts against a wall of the oblique groove, and another end of the compression spring elastically abuts against the oblique end of the positioning block.

Preferably, an upper side of the sealing disk is formed with a rotating shaft. A middle portion of the sealing seat is formed with a shaft hole. The rotating shaft is rotatably disposed in the shaft hole. The driven disk is secured on the rotating shaft so that the driven disk is coaxially connected to the sealing disk.

Preferably, the shower head button switching structure further comprises a sealing cover. The sealing cover is configured to cover the sealing seat. The sealing disk is rotatably disposed between the sealing cover and the sealing seat. The sealing disk is provided with a water hole. The sealing cover is provided with water diversion holes. The sealing disk is rotatable for the water hole to communicate with the water diversion holes to achieve water flow switching. A middle portion of a lower side of the sealing disk is provided with first non-return teeth arranged annularly. A middle portion of the sealing cover is formed with a plurality of second non-return teeth corresponding to the first non-return teeth. Through the first non-return teeth to cooperate with the second non-return teeth, the sealing disk and the driven disk are only rotated in one direction along with the driving disk and unable to be returned back. When the sealing disk is rotated, an interaction between oblique surfaces of the first non-return teeth and the second non-return teeth enables the sealing disk to float up and down.

Preferably, the rear end of the push lever is formed with a cylindrical post. The sealing seat is formed with a receiving groove. One end of the return spring is fitted on the cylindrical post, and the other end of the return spring is inserted into the receiving groove.

Preferably, a rear end of the sealing seat is formed with a pair of pivot holes. Two sides of the middle portion of the push block are formed with a pair of short shafts corresponding to the pair of pivot holes. The short shafts of the push block are inserted into the pivot holes so that the push block is pivotally connected to the sealing seat.

Preferably, the fixing seat is a connector. The rear end of the sealing seat is connected with a water tube through the connector. An immovable end of the button is hinged to the connector.

Preferably, one side of the fixing seat is formed with a hinge shaft. The immovable end of the button is formed with a hinge hole corresponding to the hinge shaft. The button is hinged to the fixing seat through the hinge shaft to cooperate with the hinge hole.

Preferably, the push lever has an L type.

With the above technical solution, the water flow switching function of the present invention is implemented as follows: when the button is pressed, the free end of the button press the push block, the push block swings upward to push the push lever forward, and the return spring is compressed to accumulate force. The front end of the push lever is moved along the limiting guide slot. At the same time, the driving disk is driven to rotate in one direction by the cooperation of the rack at the front end of the push lever and the gear portion of the driving disk. Because the driving disk is movably connected with the push lever through the gear connection, the push lever won't be deformed to avoid jamming. When the driving disk is rotated, the positioning block installed on the driving disk extends out to engage one of the teeth of the driven disk so as to drive the driven disk to rotate, and the sealing disk coaxially connected with the driven disk is also rotated simultaneously to achieve water flow switching. When the button is released, the compressed return spring pushes the push lever back, the push block swings downward, and the free end of the button is pushed upward by the push block. In this process, the driving disk is also rotated and returned back with the back movement of the push lever, and the positioning block is also moved along with the driving disk. The positioning block is retracted by the acting force of the oblique surface of the teeth of the driven disk, so the positioning block does not drive the driven disk to rotate. The positioning block is moved to engage the next one of the teeth after being moved a certain distance, waiting for the next press movement.

The present invention has the following features:

1. The push lever and the driving disk are linked together through the rack of the push lever and the gear portion of the driving disk. The two components can be relatively moved, so that the push lever won't be deformed when the driving disk is rotated, thereby avoiding the problem that the switch is not smooth.

2. The sealing seat is provided with the limiting guide slot to guide the push lever to be reciprocated back and forth and further to improve the stability of the switching action.

3. The driven disk is fitted in the driving disk, and the two are on the same plane, which is beneficial for the miniaturization of the shower head.

4. The driven disk is provided with tooth arranged annularly to cooperate with the retractable positioning block mounted on the driving disk. The positioning block is configured to engage one of the teeth obliquely. When the driving disk is rotated, the oblique end of the positioning block is subjected to the tangential force given by the driving disk and the thrust provided by the compression spring, so that the oblique end of the positioning block can be stably engaged with one of the teeth, and the positioning block and the driven disk will not move relative to each other.

5. Through the retractable positioning block to cooperate with the teeth of the driven disk, and the positioning block is retracted when returned, so that the driven disk won't be rotated along with the driving disk to achieve a non-return function for next switch. Therefore, the structure of the present invention is simple and smart and easy for operation.

### BRIEF DESCRIPTION OF THE DRAWINGS

FIG. 1 is an exploded view of the present invention;

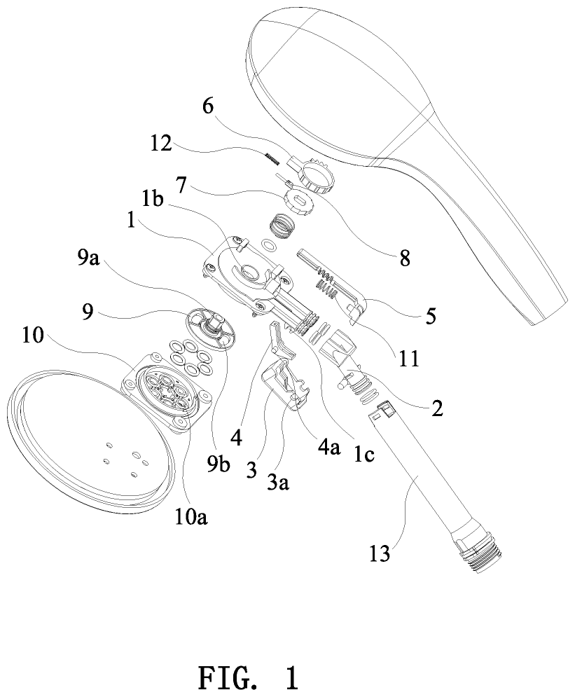

FIG. 2 is a top view of the present invention;

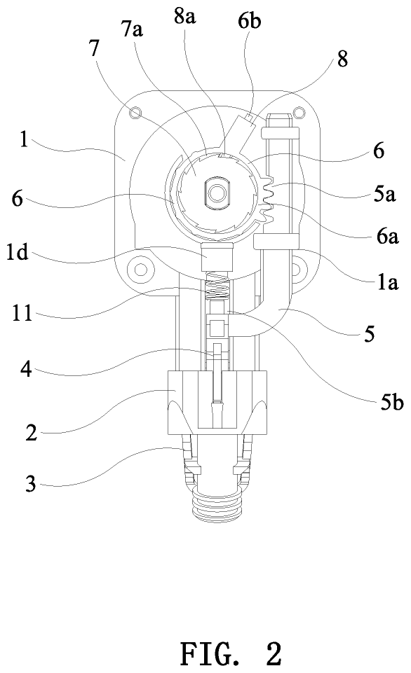

FIG. 3 is a perspective view of the present invention;

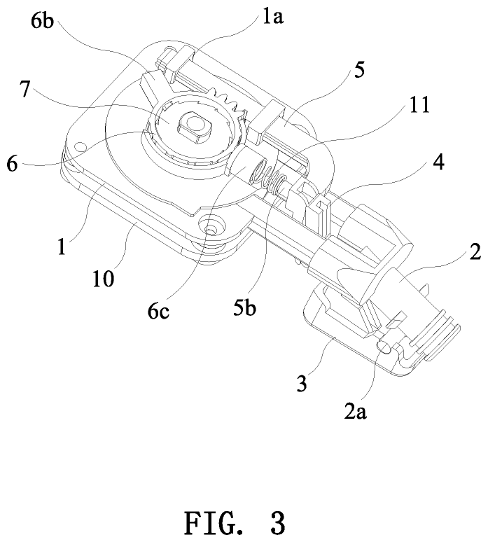

FIG. 4 is an exploded view of the push lever, the positioning block, the driving disk, the driven disk, the sealing disk and the sealing cover of the present invention;

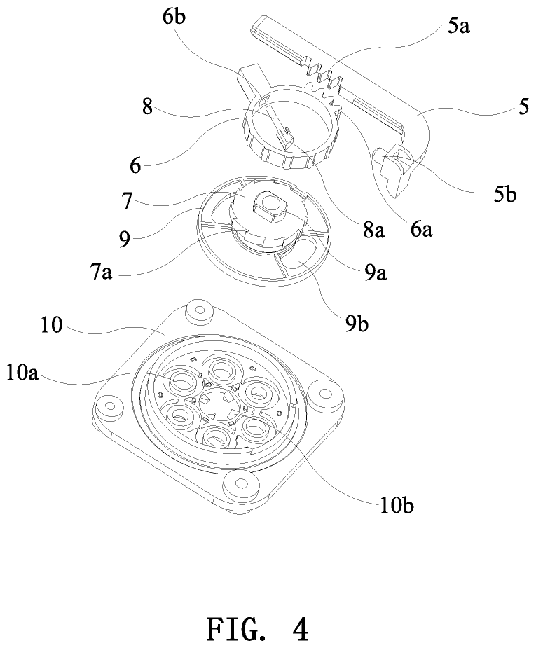

FIG. 5 is a perspective view of the sealing disk of the present invention;

FIG. 6 is a schematic view of the present invention when the button is pressed;

FIG. 7 is a schematic view of the present invention when the button is released;

FIG. 8 is a side sectional view of the shower head of the present invention when the button is pressed;

FIG. 9 is a side sectional view of the shower head of the present invention when the button is released;

FIG. 10 is a side sectional view showing the waterway of the shower head of the present invention when the button is pressed; and

FIG. 11 is a side sectional view showing the waterway of the shower head of the present invention when the button is released.

### DETAILED DESCRIPTION OF THE PREFERRED EMBODIMENTS

Embodiments of the present invention will now be described, by way of example only, with reference to the accompanying drawings.

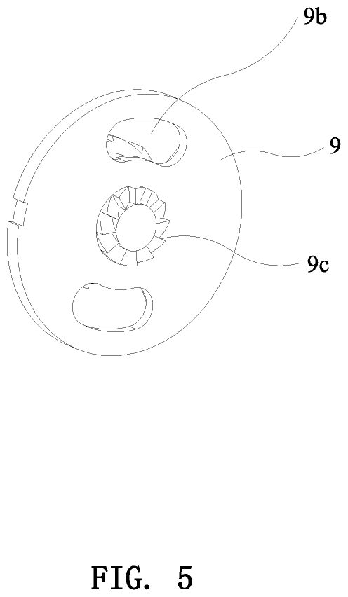

As shown in HG 1 to FIG. 5, the present invention discloses a shower head button switching structure, comprising a sealing seat 1, a fixing seat 2, a button 3, a push block 4, a push lever 5, a driving disk 6, a driven disk 7, a positioning block 8, a sealing disk 9, and a sealing cover 10.

A middle portion of the push block 4 is pivotally connected to the sealing seat 1. A free end of the button 3 is connected to one end of the push block 4 in such a manner that the push block 4 can be pressed to swing upward. An upper surface of the sealing seat 1 is formed with a limiting guide slot 1a. The push lever 5 has an L type. A front end of the push lever 5 is inserted into the limiting guide slot 1a. The push lever 5 can be reciprocated back and forth under the guidance of the limiting guide slot 1a. A rear end of the push lever 5 is connected to another end of the push block 4. When the push block 4 is swung upward, the push lever 5 is driven by the push block 4 to move forward. The front end of the push lever 5 is formed with a rack 5a. The outer periphery of the driving disk 6 is formed with a gear portion 6a to mesh with the rack 5a. When the push lever 5 is reciprocated to move back and forth, the driving disk 6 is driven by the push lever 5 to rotate through the rack 5a to cooperate with the gear portion 6a. A return spring 11 is provided between the push lever 5 and the sealing seat 1. The return spring 11 is compressed by the push lever 5 and the driving disk 6 when the push lever 5 is moved forward. When there is no external force applied to the button 3, the return spring 10 provides a returning force to push the push lever 5 backward. At this time, the push lever 5 is moved backward to drive the push block 4 to swing downward and to push the free end of the button 3 back, and the driving disk 6 is rotated and returned along with the push lever 5.

The driven disk 7 is disposed in the driving disk 6. The positioning block 8 is obliquely installed in the driving disk 6 in a retractable manner. The outer periphery of the driven disk 7 is formed with teeth 7a arranged annularly. One end of the positioning block 8 is formed with an oblique end 81 corresponding to the teeth 7a of the driven disk 7. When the positioning block 8 extends outward, the oblique end 8a of the positioning block 8 is engaged with one of the teeth 7a of the driven disk 7. Through the cooperation of the oblique end 8a of the positioning block 8 and the teeth 7a of the driven disk 7, the driving disk 6 can drive the driven disk 7 to rotate in one direction. When the driving disk 6 is rotated and returned back, the positioning block 8 is retraced by the teeth 7a of the driven disk 7, and the driven disk 7 is not rotated and returned back, enabling the oblique end 8a of the positioning block 8 to be engaged with the next one of the teeth 7a of the driven disk 7. Furthermore, the driving disk 6a is formed with an oblique groove 6b. The positioning block 8 is inserted in the oblique groove 6b. A compression spring 12 is sleeved on the positioning block 8. One end of the compression spring 12 elastically abuts against the wall of the oblique groove 6b and another end of the compression spring 12 elastically abuts against the oblique end 8a. The function of the compression spring 12 is to help the positioning block 8 extend out and retract in the oblique groove 6b. That is, when the button 3 is pressed, the compression spring 12 can push the positioning block 8 to extend out for the oblique end 8a of the positioning block 8 to engage one of the teeth 7a. When the button 3 is released, the positioning block 8 is rotated relative to the driven disk 7 together with the driving disk 6. The oblique surface of the teeth 7a pushes the positioning block 8 to be retracted into the oblique groove 6b. At this time, the compression spring 12 is compressed until the positioning block 8 is engaged with the next one of the teeth 7a, and the compression spring 12 is again extended to push the positioning block 8 out of the oblique groove 6b.

The sealing disk 9 is coaxially connected with the driven disk 7 so that when the driving disk 6 drives the driven disk 7 to rotate, the sealing disk 9 can be simultaneously rotated to achieve water flow switching.

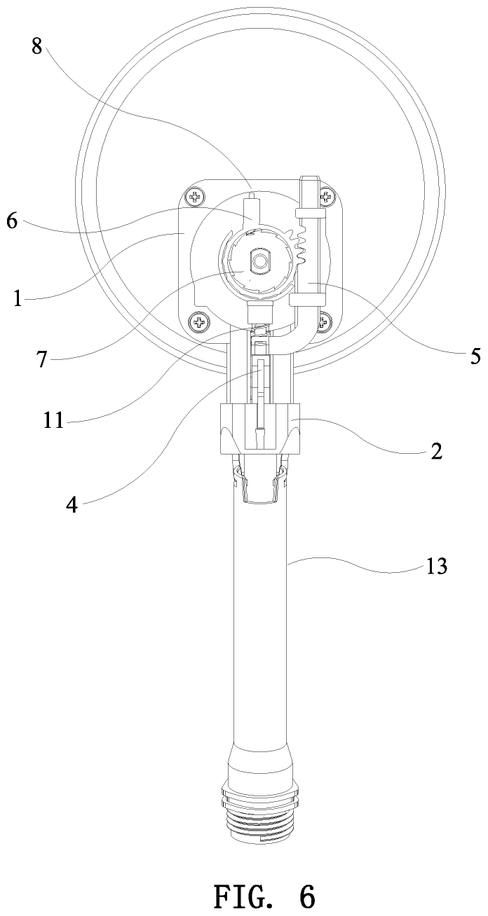

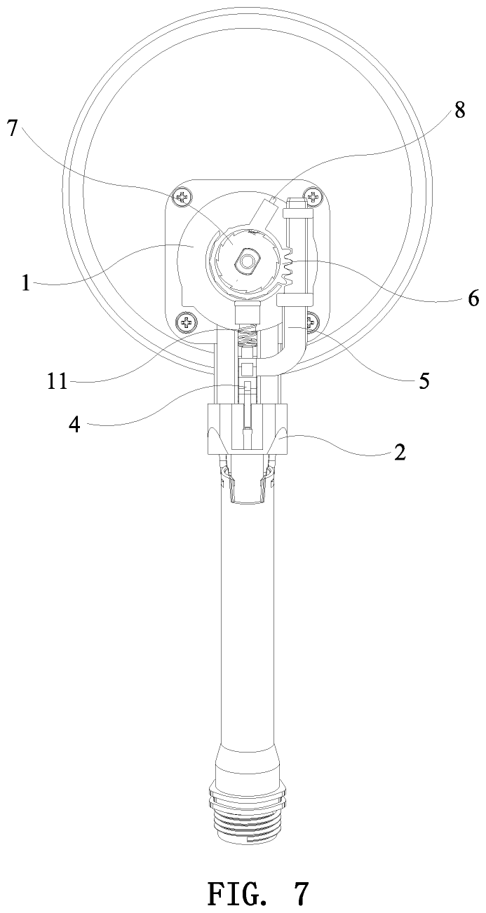

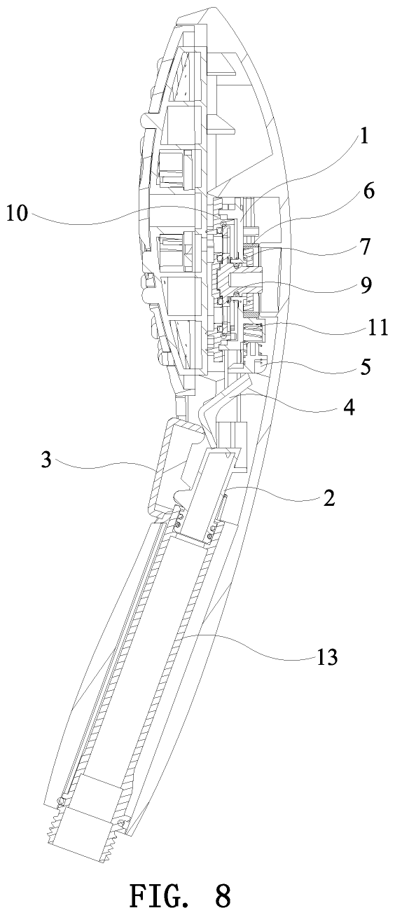

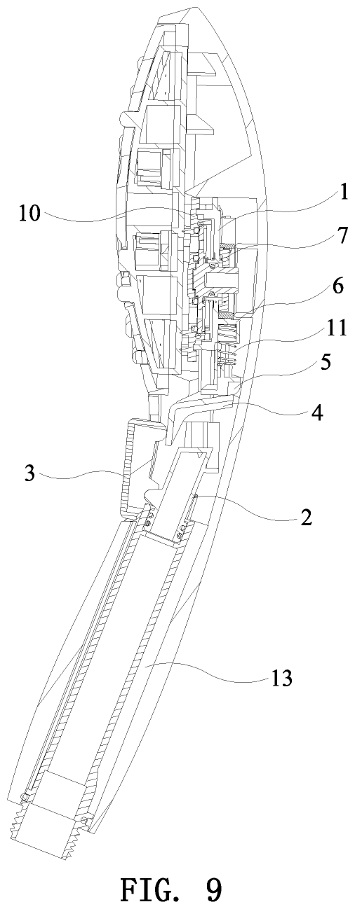

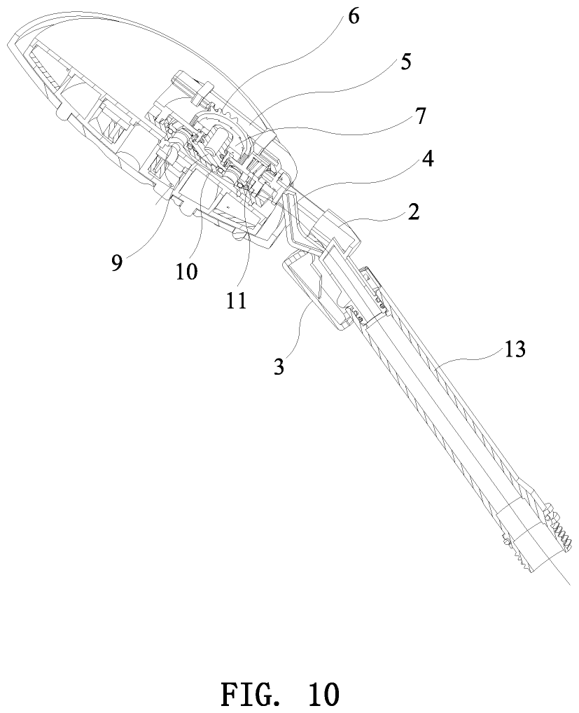

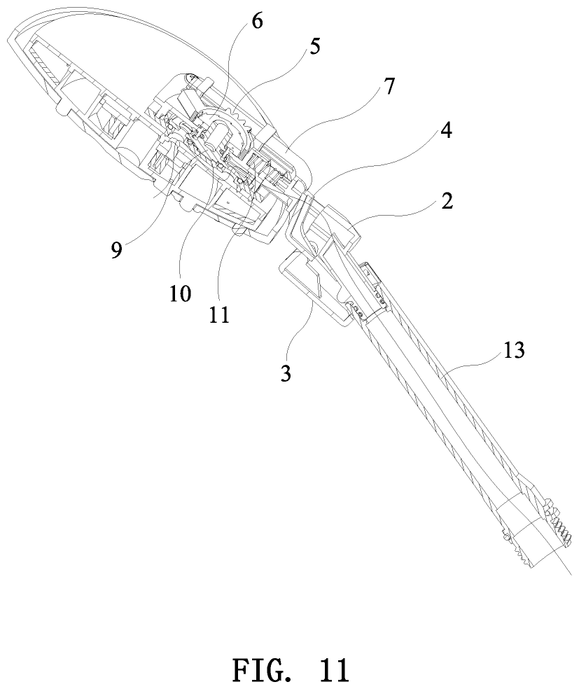

Referring to FIGS. 6-11, the water flow switching function of the present invention is implemented as follows: when the button 3 is pressed, the free end of the button 3 press the push block 4, the push block 4 swings upward to push the push lever 5 forward, and the return spring 11 is compressed to accumulate force. The front end of the push lever 5 is moved along the limiting guide slot 1a. At the same time, the driving disk 6 is driven to rotate in one direction by the cooperation of the rack 5a at the front end of the push lever 5 and the gear portion 6a of the driving disk 6. Because the driving disk 6 is movably connected with the push lever 5 through the gear connection, the push lever 5 won't be deformed and to avoid a jam. When the driving disk 6 is rotated, the positioning block 8 installed on the driving disk 6 extends out to engage one of the teeth 7a of the driven disk 7 so as to drive the driven disk 7 to rotate, and the sealing disk 9 coaxially connected to the driven disk 7 is also rotated simultaneously to achieve water flow switching. When the button 3 is released, the compressed return spring 11 pushes the push lever 5 back, the push block 4 swings downward, and the free end of the button 3 is pushed back by the push block 4. In this process, the driving disk 6 is also rotated and returned back with the rearward movement of the push lever 5, and the positioning block 8 is also moved along with the driving disk 6. The positioning block 8 is retracted by the acting force of the oblique surface of the teeth of the driven disk 7, so the positioning block 8 does not drive the driven disk 7 to rotate but is moved relative to the driven disk 7. The positioning block 8 is moved to engage the next one of the teeth 7a after being moved a certain distance, waiting for the next press movement. The oblique end 8a of the positioning block 8 of the present invention enters one of the teeth 7a at an angle. At the same time, the driving disk 6 drives the positioning block 8 to rotate, so that the oblique end 8a of the positioning block 8 applies a force in a tangential direction to the driven disk 7, and the oblique end 8a of the positioning block 8 is engaged in one of the teeth 7a stably. This way is labor-saving, and the switching is smoother and more stable.

Furthermore, a rotating shaft 9a is provided on an upper side of the sealing disk 9. A middle portion of the sealing seat 1 is formed with a shaft hole 1b. The rotating shaft 9a is rotatably disposed in the shaft hole 1b. The driven disk 7 is secured on the rotating shaft 9a so that the driven disk 7 is coaxially connected to the sealing disk 9. When the driven disk 7 is rotated, the sealing disk 9 is rotated simultaneously. The sealing cover 10 is to cover the sealing seat 1. The sealing disk 9 is rotatably disposed between the sealing cover 10 and the sealing seat 1. The sealing disk 9 is provided with a water hole 9b. The sealing cover 10 is provided with water diversion holes 10a. The sealing disk 9 can be rotated for the water hole 9b to communicate with the different water diversion holes 10a to achieve water flow switching.

In order to obtain a better non-return effect, in this embodiment, a middle portion of a lower side of the sealing disk 9 is provided with first non-return teeth 9c arranged annularly. A middle portion of the sealing cover 10 is formed with a plurality of second non-return teeth 10b corresponding to the first non-return teeth 9c. Due to the cooperation of the first non-return teeth 9c and the second non-return teeth 10b, the sealing disk 9 and the driven disk 7 can be rotated only in one direction along with the driving disk 6 and cannot be rotated reversely. That is, the first non-return teeth 9c cooperate with the second non-return teeth 10b to form a non-return structure. In addition, when the sealing disk 9 is rotated, the interaction between the oblique surfaces of the first non-return teeth 9c and the second non-return teeth 10b enables the sealing disk 9 to float up and down to reduce the water pressure acting on the sealing disk 9, and the force required for switching is less.

In order to facilitate the installation of the return spring 11, the rear end of the push lever 5 is formed with a cylindrical post 5b. The sealing seat 1 is formed with a receiving groove 1d. One end of the return spring 11 is fitted on the cylindrical post 5b, and the other end of the return spring 11 is inserted into the receiving groove 1d.

Furthermore, the rear end of the sealing seat 1 is formed with a pair of pivot holes 1c. Two sides of the middle portion of the push block 4 are formed with a pair of short shafts 4a corresponding to the pair of pivot holes 1c. The short shafts 4a of the push block 4 are inserted into the pivot holes 1c so that the push block 4 is pivotally connected to the sealing seat 1.

Furthermore, the fixing seat 2 is a connector. The rear end of the sealing seat 1 is connected with a water tube 13 through the connector. An immovable end of the button 3 is hinged to the connector.

Furthermore, one side of the fixing seat 2 is formed with a hinge shaft 2a. The immovable end of the button 3 is formed with a hinge hole 3a corresponding to the hinge shaft 2a. The button 3 is hinged to the fixing seat 2 through the cooperation of the hinge shaft 2a and the hinge hole 3a.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A shower head button switching structure, comprising a sealing seat, a fixing seat, a button, a push block, a push lever, a driving disk, a driven disk, a positioning block, and a sealing disk;
a middle portion of the push block being pivotally connected to the sealing seat, a free end of the button being connected to one end of the push block in such a manner that the push block can be pressed to swing upward; an upper surface of the sealing seat being formed with a limiting guide slot, a front end of the push lever being inserted in the limiting guide slot and movable back and forth, a rear end of the push lever being connected to another end of the push block, wherein when the push block is swung upward, the push lever is driven by the push block to move forward; the front end of the push lever being formed with a rack, an outer periphery of the driving disk being formed with a gear portion to mesh with the rack, wherein when the push lever is reciprocated to move back and forth, the driving disk is driven by the push lever to rotate through the rack to cooperate with the gear portion; a return spring being provided between the push lever and the sealing seat, the return spring being compressed when the push lever is moved forward, wherein when the button is not applied with an external force, the push lever is pushed back by the return spring to drive the push block to swing downward and to return the free end of the button and the driving disk back;
the driven disk being disposed in the driving disk, the positioning block being obliquely installed in the driving disk in a retractable manner, an outer periphery of the driven disk being formed with teeth arranged annularly, one end of the positioning block being formed with an oblique end corresponding to the teeth of the driven disk, wherein when the positioning block extends outward, the oblique end of the positioning block is engaged with one of the teeth of the driven disk; through the oblique end of the positioning block to cooperate with the teeth of the driven disk, the driving disk being able to drive the driven disk to rotate in one direction; wherein when the driving disk is rotated and returned back, the positioning block is retraced by the teeth of the driven disk so that the driven disk is not rotated and returned back, enabling the oblique end of the positioning block to be engaged with the next one of the teeth of the driven disk;
the sealing disk being coaxially connected with the driven disk so that when the driving disk drives the driven disk to rotate, the sealing disk can be simultaneously rotated to achieve water flow switching.

2. The shower head button switching structure as claimed in claim 1, wherein the driving disk is formed with an oblique groove, the positioning block is inserted in the oblique groove, a compression spring is sleeved on the positioning block, one end of the compression spring elastically abuts against a wall of the oblique groove, and another end of the compression spring elastically abuts against the oblique end of the positioning block.

3. The shower head button switching structure as claimed in claim 1, wherein an upper side of the sealing disk is formed with a rotating shaft, a middle portion of the sealing seat is formed with a shaft hole, the rotating shaft is rotatably disposed in the shaft hole, and the driven disk is secured on the rotating shaft so that the driven disk is coaxially connected to the sealing disk.

4. The shower head button switching structure as claimed in claim 3, further comprising a sealing cover, the sealing cover being configured to cover the sealing seat, the sealing disk being rotatably disposed between the sealing cover and the sealing seat, the sealing disk being provided with a water hole, the sealing cover being provided with water diversion holes, the sealing disk being rotatable for the water hole to communicate with the water diversion holes to achieve water flow switching;
a middle portion of a lower side of the sealing disk being provided with first non-return teeth arranged annularly, a middle portion of the sealing cover being formed with a plurality of second non-return teeth corresponding to the first non-return teeth, through the first non-return teeth to cooperate with the second non-return teeth, the sealing disk and the driven disk being rotated only in one direction along with the driving disk and unable to be returned back, wherein when the sealing disk is rotated, an interaction between oblique surfaces of the first non-return teeth and the second non-return teeth enables the sealing disk to float up and down.

5. The shower head button switching structure as claimed in claim 1, wherein the rear end of the push lever is formed with a cylindrical post, the sealing seat is formed with a receiving groove, one end of the return spring is fitted on the cylindrical post, and the other end of the return spring is inserted into the receiving groove.

6. The shower head button switching structure as claimed in claim 1, wherein a rear end of the sealing seat is formed with a pair of pivot holes, two sides of the middle portion of the push block are formed with a pair of short shafts corresponding to the pair of pivot holes, and the short shafts of the push block are inserted into the pivot holes so that the push block is pivotally connected to the sealing seat.

7. The shower head button switching structure as claimed in claim 1, wherein the fixing seat is a connector, a rear end of the sealing seat is connected with a water tube through the connector, and an immovable end of the button is hinged to the connector.

8. The shower head button switching structure as claimed in claim 1, wherein one side of the fixing seat is formed with a hinge shaft, an immovable end of the button is formed with a hinge hole corresponding to the hinge shaft, and the button is hinged to the fixing seat through the hinge shaft to cooperate with the hinge hole.

9. The shower head button switching structure as claimed in claim 1, wherein the push lever has an L type.
